(19) United States
(12) Patent Application Publication
(10) Pub. No.: US 2019/0159616 A1
(43) Pub. Date: May 30, 2019

(54) SPORK WITH BREAKING TANK FUNCTION

(71) Applicants: Qiding LV, Hangzhou (CN); Hangzhou Liantu Trading Co., Ltd., Hangzhou (CN)

(72) Inventor: Qiding LV, Hangzhou (CN)

(73) Assignees: Hangzhou Liantu Trading Co., Ltd., Hangzhou (CN); Qiding LV, Hangzhou (CN)

(21) Appl. No.: 15/885,812

(22) Filed: Feb. 1, 2018

(30) Foreign Application Priority Data
Nov. 24, 2017 (CN) 201721601378.2

(51) Int. Cl. A47G 21/02

(52) U.S. Cl. CPC A47G 21/02; F17C 1/00

(57) ABSTRACT

The present invention provides a spork with a breaking tank function, including: a spork main body, wherein an end of a handle of the spork main body is provided with a hook-shaped structure; and a breaking tank structure, wherein the breaking tank structure is disposed at the handle and cooperates with the hook-shaped structure to break a tank body. The structure of the present invention is simple, which can be used as not only a spork but also a breaking tank device. The effect of one article with dual usages is achieved, which meets the lightweight requirement of outdoor activities.

### CROSS-REFERENCE TO RELATED APPLICATIONS

This Non-provisional application claims priority under 35 U.S.C. § 119(a) on Patent Application No(s). 201721601378. 2 filed in People's Republic of China on Nov. 24, 2017, the entire contents of which are hereby incorporated by reference.

### BACKGROUND OF THE INVENTION

### Field of the Invention

The present invention relates to an auxiliary tool for outdoor use, and more particularly, to a spork with a breaking tank function.

### Description of the Related Art

With the continuous improvement of the living standard, more and more outdoor activities become an indispensable part of people's lives. In particular, some outdoor enthusiasts choose a barbecue or other activities in the wild, and an outdoor gas tank is often chosen as an outdoor dining fuel. As the outdoor gas tank is filled with high pressure combustible gas, after the outdoor gas tank is used up, considering the environmental safety and environmental hygiene, a tank body of the gas tank needs to be broken. Therefore, it is necessary to carry a special breaking tank tool extra when doing outdoor activities. The conventional breaking tank tool is made of metal, while its role is limited to the function of breaking the outdoor gas tank. However, the conventional breaking tank tool has to be carried throughout the whole process of doing outdoor activities, which does not meet a lightweight requirement of outdoor sports. In addition, the conventional breaking tank tool cannot break a long gas tank, and the adaptability is not very good.

### BRIEF SUMMARY OF THE INVENTION

To solve the above-mentioned problems, the present invention provides a spork with a breaking tank function to solve the problem that the breaking tank tool in the prior art needs to be carried extra while the function is single.

To solve the above-mentioned problems, the present invention provides a spork with a breaking tank function, including: a spork main body, an end of a handle of the spork main body is provided with a hook-shaped structure; and a breaking tank structure, the breaking tank structure is disposed at the handle and cooperates with the hook-shaped structure to break a tank body.

In the present invention, by designing the end of the handle of the spork main body as the hook-shaped structure, and then disposing the breaking tank structure at the end of the handle, the hook-shaped structure and the breaking tank structure form a structure similar to a bottle opener, and the two cooperate with each other to break part at the outdoor gas tank bottom near a curling edge. The structure of the present invention is simple, which can not only be used as a spork but also as a breaking tank device, and a combination of the two functions reduces the lightweight requirement of outdoor sports.

The present invention is further improved in that the breaking tank structure may be connected with the spork main body through a rivet.

The present invention is further improved in that the breaking tank structure may be capable of rotating around the rivet.

The present invention is further improved in that the spork main body may be provided with a limiting block, and the limiting block may be disposed at one side of the breaking tank structure rotating away from the hook-shaped structure to limit rotation of the breaking tank structure.

The present invention is further improved in that the breaking tank structure may be provided with a notch cooperating with the limiting block.

The present invention is further improved in that the breaking tank structure may be integrally formed with the spork main body.

The present invention is further improved in that an end of the breaking tank structure may be tip-shaped.

The present invention is further improved in that, a centre of the handle of the spork main body may be provided with a sunken platform depressed downward.

Compared with the prior art, beneficial effects of the present invention lie in:

In the present invention, by designing the end of the handle of the spork main body as the hook-shaped structure, and then disposing the breaking tank structure at the end of the handle, the hook-shaped structure and the breaking tank structure form a structure similar to a bottle opener, and the two cooperate with each other to break the part at the bottom of the outdoor gas tank bottom near a curling edge. The structure of the present invention is simple, which can be used as not only a spork but also a breaking tank device, and the combination of the two functions meets the lightweight requirement of outdoor activities.

### BRIEF DESCRIPTION OF THE DRAWINGS

FIG. 1 is an exploded diagram of a spork with breaking tank function according to a preferred Embodiment One of the present invention;

FIG. 2 is a schematic diagram of the spork with breaking tank function according to the preferred Embodiment One of the present invention; and

FIG. 3 is a schematic diagram of the spork with breaking tank function according to the preferred Embodiment Two of the present invention.

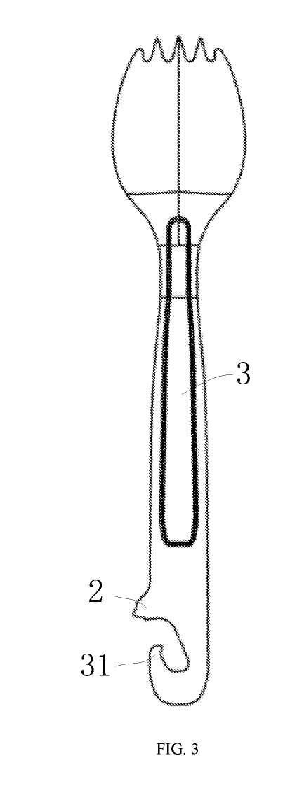

### FIGURE REFERENCE NUMERALS

1. rivet; 2. breaking tank structure; 21. tip; 3. spork main body; 31. hook-shaped structure; 32. limiting block; and 33. notch.

### DETAILED DESCRIPTION OF THE INVENTION

The above-mentioned and other technical features and advantages of the present invention will be clearly and completely described with reference to the accompanying drawings. Apparently, the described embodiments are merely some but not all the embodiments of the present invention.

The present invention provides a spork with breaking tank function. An outdoor gas tank needs to be carried for an outdoor barbecue activity. As the outdoor gas tank is filled with high pressure combustible gas, the tank body of the gas tank needs to be broken after the outdoor gas tank is used up. Therefore, it is necessary to carry a special breaking tank tool, which increases a carrying burden in outdoor activities and has a limited effect. By combing the spork with the breaking tank tool, the structure provided in the present invention is simple and the outdoor carrying burden is reduced. The structure of the spork with breaking tank function of the present invention will be described below with reference to the accompanying drawings.

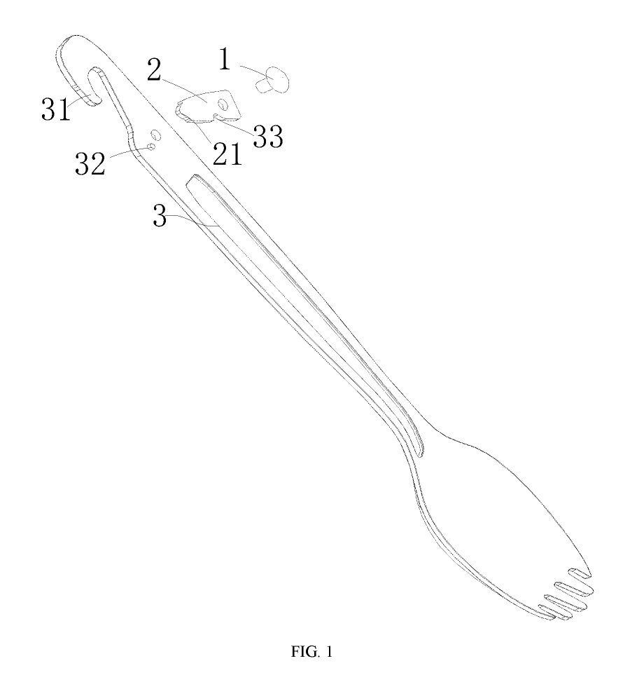

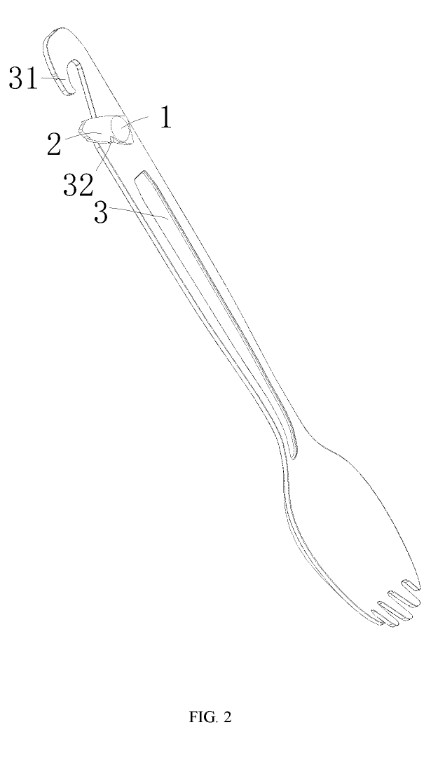

Please refer to FIG. 1 and FIG. 2. The present invention provides a spork with breaking tank function, including a spork main body 3 and a breaking tank structure 2. The spork main body 3 is formed by a spork body formed integrally with a handle. An end of the handle of the spork main body 3 is provided with a hook-shaped structure 31 for engaging with the bottom of a gas tank. The breaking tank structure 2 is disposed at the handle of the spork main body 3 to cooperate with the hook-shaped structure 31, which forms a structure like a bottle opener of a beer bottle and then acts at the part of the bottom of the outdoor gas tank near a curling edge. Take the hook-shaped structure 31 at the end of the handle as a fulcrum to hook the wall of the gas tank, then take the top of the breaking tank structure 2 as the force receiving point, and apply force at the handle to break the outdoor gas tank.

As a preferred Embodiment One of the present invention, the breaking tank structure 2 is connected with the spork main body 3 through a rivet 1. Therefore, the breaking tank structure 2 can be rotated with the rivet 1 as a fulcrum. However, in order to limit a rotation angle of the breaking tank structure 2 and to facilitate storage of the spork, the handle of the spork main body 3 is provided with a limiting block 32, and the limiting block 32 is disposed at one side of the breaking tank structure 2 rotating away from the hook-shaped structure 31 to limit the rotation of the breaking tank structure 2. The breaking tank structure 2 is rotated out when used, and the breaking tank structure 2 is aligned with the handle of the spork after use.

In order to ensure the limiting accuracy and reduce deformation of the breaking tank structure 2 in the force receiving process, the breaking tank structure 2 is provided with a notch 33 cooperating with the limiting block 32 on the sport main body 3.

As a preferred Embodiment Two of the present invention, the breaking tank structure 2 is integrally formed with the spork main body 3. Break the outdoor gas tank by choosing a specific angle.

In order to facilitate breaking the outdoor gas tank by the breaking tank structure 2, an end of the breaking tank structure 2 is provided with a tip 21, which has a relatively direct destructive effect.

Preferably, the spork handle of the spork main body is provided with a sunken platform depressed downward, which can increase the strength of the handle effectively.

By designing the end of the handle of the spork main body as the hook-shaped structure, and then disposing the breaking tank structure at the end of the handle, the hook-shaped structure and the breaking tank structure can form a structure similar to a bottle opener, and the two cooperate with each other to break the part at the bottom of the outdoor gas tank near the curling edge. The structure of the present invention is simple, the product can be used as not only a spork but also a breaking tank device, and the combination of the two functions meets the lightweight requirement of the outdoor activities. What's more, the present invention can break not only the flat gas tank but also the long gas tank, and the adaptability is stronger.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A spork with a breaking tank function comprising:
a spork main body, an end of a handle of the spork main body being provided with a hook-shaped structure; and
a breaking tank structure, the breaking tank structure being disposed at the handle and cooperating with the hook-shaped structure to break a tank body.

2. The spork with the breaking tank function according to claim 1, wherein the breaking tank structure is connected with the spork main body through a rivet.

3. The spork with the breaking tank function according to claim 2, wherein the breaking tank structure is capable of rotating around the rivet.

4. The spork with the breaking tank function according to claim 3, wherein the spork main body is provided with a limiting block, and the limiting block is disposed at one side of the breaking tank structure rotating away from the hook-shaped structure to limit rotation of the breaking tank structure.

5. The spork with the breaking tank function according to claim 4, wherein the breaking tank structure is provided with a notch cooperating with the limiting block.

6. The spork with the breaking tank function according to claim 1, wherein the breaking tank structure is integrally formed with the spork main body.

7. The spork with the breaking tank function according to claim 1, wherein an end of the breaking tank structure is tip-shaped.

8. The spork with the breaking tank function according to claim 1, wherein a center of the handle of the spork main body is provided with a sunken platform depressed downward.
